(19) United States
(12) Patent Application Publication
(10) Pub. No.: US 2025/0175413 A1
(43) Pub. Date: May 29, 2025

(54) BROADBAND ACCESS OVER ETHERNET VIRTUAL PRIVATE NETWORK TRANSPORT TO REDUNDANT BROADBAND NETWORK GATEWAY SERVICE INSTANCES

(71) Applicant: AT&T Intellectual Property I, L.P., Atlanta, GA (US)

(72) Inventors: Jeffrey Purdin, Allen, TX (US); James Uttaro, Staten Island, NY (US); Jeffrey Hancock, Fairfax, VA (US)

(73) Assignee: AT&T Intellectual Property I, L.P., Atlanta, GA (US)

(21) Appl. No.: 18/521,435

(22) Filed: Nov. 28, 2023

(51) Int. Cl. H04L 45/28; H04L 12/46; H04L 45/02

(52) U.S. Cl. CPC H04L 45/28; H04L 12/4641; H04L 45/04

(57) ABSTRACT

Aspects of the subject disclosure may include, for example, creating network reachability on a layer 3 internet protocol underlay network between a subscriber access point and a first broadband network gateway (BNG) and between the subscriber access point and a second BNG, establishing Ethernet Virtual Private Network Virtual Private Wire Service (EVPN VPWS) Headend (HE) layer 2 termination between the subscriber access point and the first BNG and between the subscriber access point and the second BNG. Embodiments further include receiving a first advertisement of Ethernet Virtual Interface (EVI) reachability from the first BNG, receiving a second advertisement of EVI reachability from the second BNG, selecting the first BNG as a primary path for subscriber Virtual Local Area Network (VLAN) traffic for one or more subscriber devices, mapping a VLAN of the subscriber access point to a first EVPN VPWS tunnel for transport of the subscriber VLAN traffic to the first BNG, and communicating subscriber VLAN data over the first EVPN VPWS tunnel with the first BNG. Other embodiments are disclosed.

### FIELD OF THE DISCLOSURE

The subject disclosure relates to a system and method providing broadband access over an Ethernet Virtual Private Network (EVPN) to redundant broadband network gateway (BNG) service instances.

### BACKGROUND

Broadband service for Internet Service Providers (ISPs) continues to grow in demand both in terms of reach and coverage and bandwidth rates. Provisioning broadband service in some networks may include use of Broadband Network Gateway functions, which can be resource intensive. To keep up with such growth, ISPs seek ways to better monetize Broadband Network Gateway functions and enable resilient service in the event of a network failure.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system functioning within the communication network of FIG. 1 in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for establishing a service overlay using layer 2 Ethernet Virtual Private Network Virtual Private Wire Service tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point. This enables adding network redundancy to network access points that are already in service in the network. Other embodiments are described in the subject disclosure.

One or more aspects of the subject disclosure include creating network reachability on a layer 3 internet protocol underlay network between a subscriber access point and a first broadband network gateway (BNG) and between the subscriber access point and a second BNG, establishing Ethernet Virtual Private Network Virtual Private Wire Service (EVPN VPWS) Headend (HE) layer 2 termination between the subscriber access point and the first BNG and between the subscriber access point and the second BNG. Aspects of the subject disclosure include receiving a first advertisement of Ethernet Virtual Interface (EVI) reachability from the first BNG, receiving a second advertisement of EVI reachability from the second BNG, selecting the first BNG as a primary path for subscriber Virtual Local Area Network (VLAN) traffic for one or more subscriber devices, mapping a VLAN of the subscriber access point to a first EVPN VPWS tunnel for transport of the subscriber VLAN traffic to the first BNG, and communicating subscriber VLAN data over the first EVPN VPWS tunnel with the first BNG. In embodiments, the first BNG is selected because the BNGs communicate among themselves to determine which BNG is active via a service carving value. That is communicated to multiplexers via primary bits and backup bits.

One or more aspects of the subject disclosure include creating layer 2 Ethernet Virtual Private Network Virtual Private Wire Service (EVPN VPWS) overlays on a layer 3 internet protocol underlay network to provide network access to a service provider network for a subscriber access point, establishing first network reachability between the subscriber access point and a first Broadband Network Gateway (BNG), and establishing second network reachability between the subscriber access point and a second Broadband Network Gateway (BNG). Aspects of the subject disclosure further include designating one of the first BNG and the second BNG as a primary path and another BNG of the first BNG and the second BNG as a secondary path for network access from the subscriber access point, communicating subscriber data on the primary path, detecting a network failure in the service provider network affecting the communicating subscriber data, and automatically selecting the secondary path for communicating further subscriber data in response to the detecting the network failure.

One or more aspects of the subject disclosure include establishing, by a processing system including a processor, a first layer 2 Ethernet Virtual Private Network Virtual Private Wire Service (EVPN VPWS) tunnel from a subscriber access point in a service provider network to a first broadband network gateway (BNG) over a layer 3 underlay network and establishing, by the processing system, a second layer 2 EVPN VPWS tunnel from the subscriber access point to a second broadband network gateway (BNG) over the layer 3 underlay network. Aspects of the disclosure further include designating the first layer 2 EVPN VPWS tunnel as a primary path for subscriber communication in the service provider network, designating the second layer 2 EVPN VPWS tunnel as a secondary path for the subscriber communication in the service provider network, communicating subscriber data on the primary path, detecting a network failure in the service provider network affecting the communicating subscriber data, and automatically selecting the second layer 2 EVPN VPWS tunnel for communicating the subscriber data in response to the detecting the network failure.

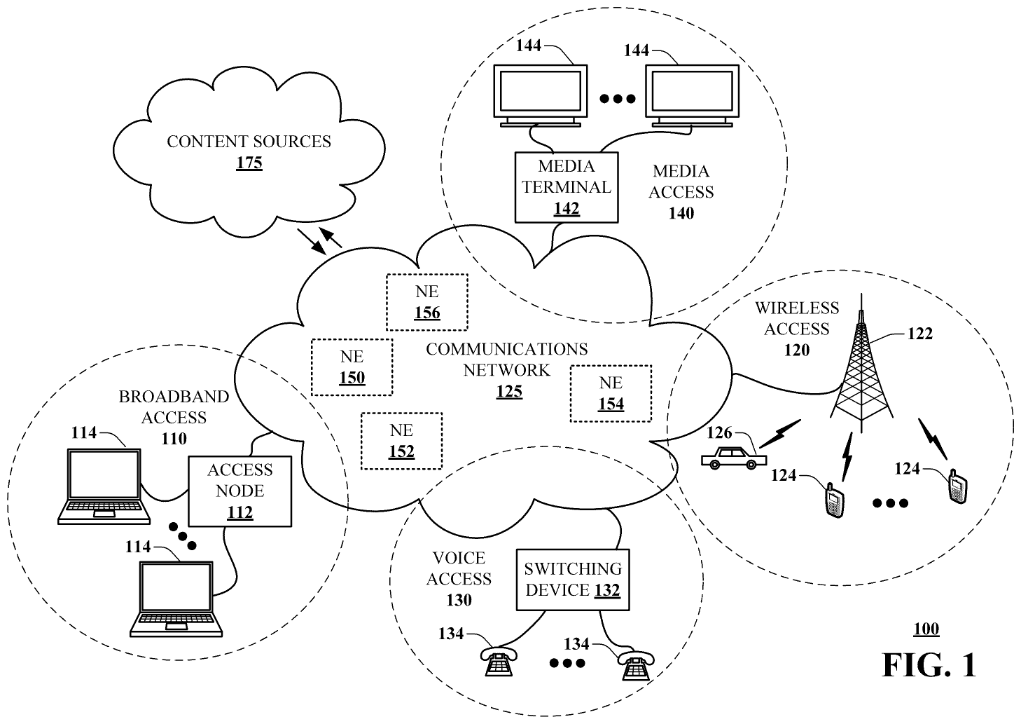

Referring now to FIG. 1, a block diagram is shown illustrating an example, non-limiting embodiment of a system 100 in accordance with various aspects described herein. For example, system 100 can facilitate in whole or in part establishing a service overlay using layer 2 EVPN VPWS tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point. In particular, a communications network 125 is presented for providing broadband access 110 to a plurality of data terminals 114 via access node 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175 as well as communication with core network 177. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, Ultra Wideband network, personal area network or other wireless access network, a broadcast satellite network and/or other communications network.

In various embodiments, the access node 112 can include a digital subscriber line access multiplexer (DSLAM), cable modem termination system (CMTS), optical line terminal (OLT) and/or other access terminal. The access node 112 provides data communication between the communications network 125 and data terminals 114 at a subscriber location. The data terminals 114 can include personal computers, laptop computers, netbook computers, tablets or other computing devices. The data terminals may communicate data with the communications node using any suitable technology including digital subscriber line (DSL) modems, data over coax service interface specification (DOCSIS) modems or other cable modems, a wireless modem such as a 4G, 5G, or higher generation modem, an optical modem and/or other access devices. In some embodiments for improved data capacity and reliability, fiber optic coupling may be used for communication between the access node 112 and the network elements such as network element 150 of the communications network 125.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable set-top box (STB), an internet protocol television (IPTV) or over the top STB, a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and network elements such as the network elements 150, 152, 154, 156, etc. can include service switching points, signal transfer points, service control points, network gateways, media distribution hubs, servers, firewalls, routers, edge devices, core network elements, switches and other network nodes for routing and controlling communications traffic over wired, optical and wireless links as part of the Internet and other public networks as well as one or more private networks, for managing subscriber access, for billing and network management and for supporting other network functions.

In some network applications, a network operator may have a large number of access nodes such as access node 112 at diverse geographic locations. The access nodes provide last-mile service, coupling subscriber locations and subscriber equipment to a remote office of the network operator. The remote office in turn is connected to a network such as communications network 125 via high data capacity connections such as fiber lines. The subscribers obtain a variety of network services from the network operator including access to the public internet and other networks via access nodes such as the access node 112.

Conventionally, the access node 112 has been maintained by the network operator as a singleton device, a single service instance point without backup or redundancy. If the device fails or is taken out of service for maintenance, the subscribers associated with the data terminals 114 are disconnected from service for a time.

To improve network reliability, it may be desirable to provide redundant connections to access nodes such as the access node 112. The network operator may seek to couple one or more access nodes such as access node 112 to multiple network destinations in order to home the access nodes to two different network locations or redundant network locations for the service instance in order to create more of a centralized and more efficient service point. Further, the network operator may seek to home the access points across a multi-vendor network using existing data communication standards such as internet protocol (IP) and multiprotocol label switching (MPLS).

In an example to address these requirements, in accordance with various aspects described herein, the network operator may implement Ethernet Virtual Private Network (EVPN) tunnels to a primary broadband network gateway (BNG) and to a secondary broadband network gateway, also referred to as a standby BNG or backup BNG. A BNG serves as an access point for subscribers, through which the subscribers connect via devices such as data terminals 114 to the broadband network. When a connection is established between the BNG and customer premise equipment (CPE), the subscriber can access broadband services provided by the network operator such as a Network Service Provider (NSP) or Internet Service Provider (ISP). The network operator can then steer traffic from a remotely located access node to either the primary BNG or the secondary BNG via the EVPN tunnels.

The EVPN allows connection between the remote access nodes and a BNG using a Layer 2 virtual bridge, where Layer 2 refers to the data link layer of the Open Systems Interconnect (OSI) model. The data link layer (DLL) establishes and terminates a connection between two physically connected nodes on a network such as a simple Local Area Network (LAN) or Wide Area Network (WAN). The DLL breaks up packets into frames and sends them from source to destination based on a media access control (MAC) address. The solution in accordance with various aspects described herein uses a Layer 3 IP-based underlay network over which BGP announced EVPN tunnel endpoints are then created and distributed using a standards based iBGP Route Reflector function. Layer 3 refers to the network layer of the OSI model. Layer 3, the network layer, is responsible for packet forwarding including routing through intermediate routers, using the IP address of neighboring network nodes.

Layer 2 devices operate at layer 2 of the OSI model, in which packets are sent to a specific switch port based on destination MAC addresses, in a point-to-point fashion. Routing operates at layer 3, where packets are sent to a specific next-hop IP address, based on destination IP address. The solution described herein in effect turns layer 2 from a static VPN to a dynamic EVPN. EVPN allows for formation of dynamic access, like VPWS. This solution takes advantage of the dynamic aspect of EVPN and allows for access over the layer 2 overlay to be dynamic and move if something on the underlay layer 3 network fails along an existing path. In effect, the solution is dynamic layer 2 signaling, with layer 2 riding on top of layer 3. The effect is a virtual point-to-point connection through the tunneling mechanism by using layer 3 routing information and then signaling the tunnels on top of the layer 3 network to build the point-to-point connection dynamically. Logically, it appears as if the access node is connected directly to the BNG through a very long layer 2 connection such as an Ethernet cable.

This arrangement thus solves for a resiliency or redundancy problem within the network, but in a way that allows the network as an underlay to switch the traffic over when there's a failure without having to go in and do a lot of manual intervention or reprovisioning of network elements.

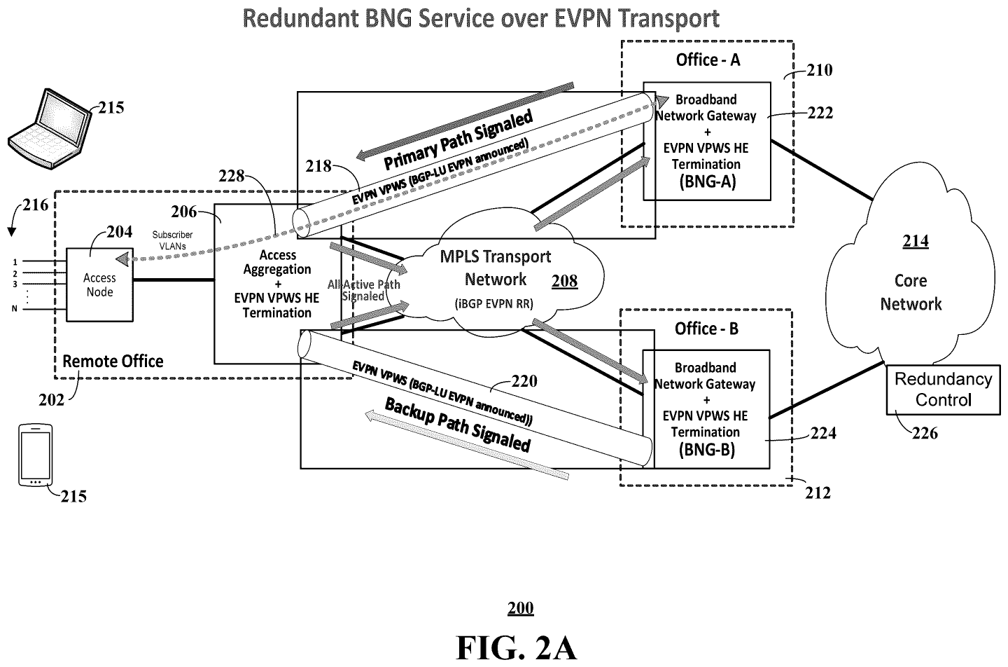

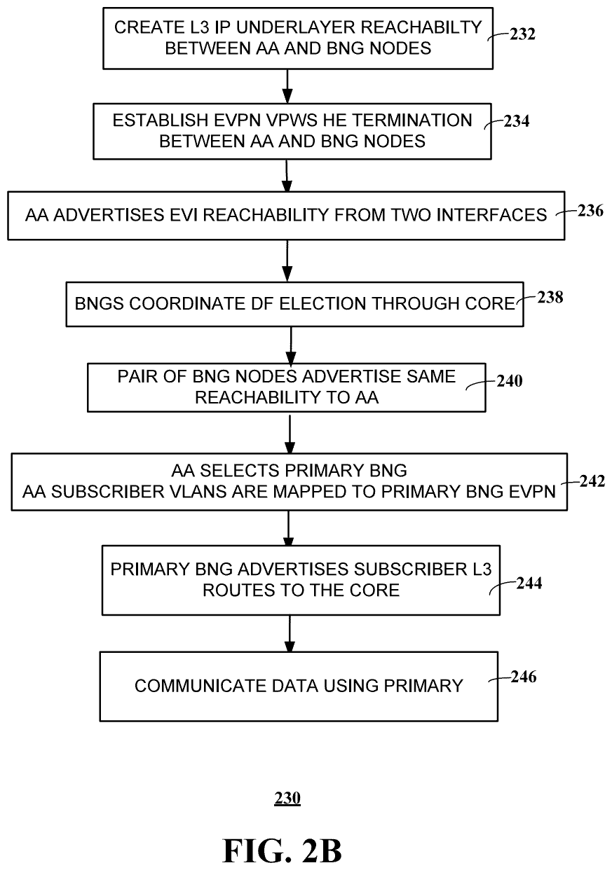

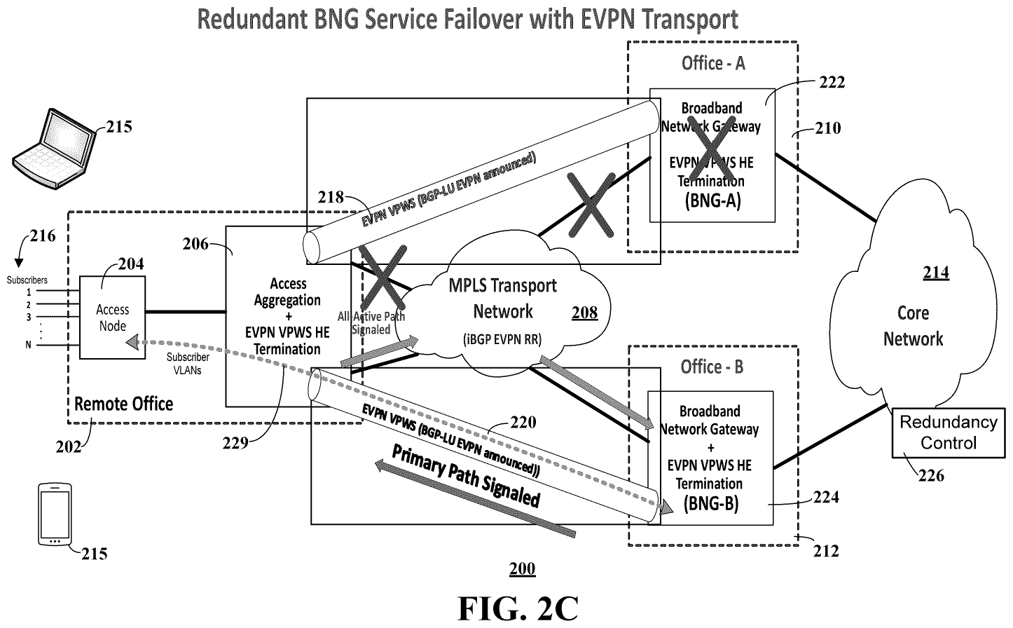

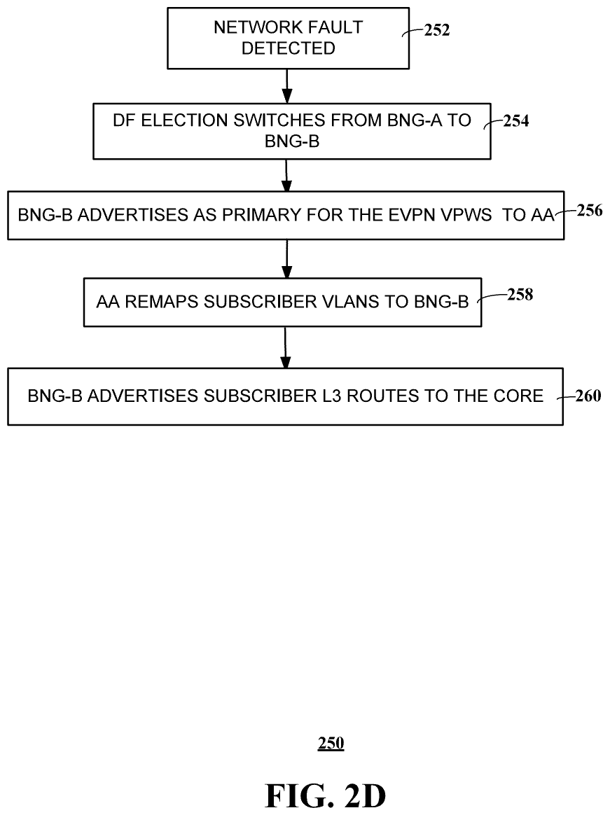

FIG. 2A is a block diagram illustrating an example, non-limiting embodiment of a system 200 functioning within the communications network 125 of FIG. 1 in accordance with various aspects described herein. In particular the system 200 operates to enable redundancy and resiliency in a subscriber broadband network operated by a network operator. In the exemplary embodiment, the system 200 includes a remote office 202 including subscriber access equipment, a multiprotocol label switching (MPLS) network 208 connecting the remote office 202 to a first office 210 and a second office 212. The first office 210 and the second office 212 are arranged for data communication with a core network 214 of the network operator. In embodiments, the first office 210 and the second office 212 are located at different geographic locations to provide geographic diversity. If one office is offline due to a network outage, power outage, or other reason, the other office will handle all communications previously assigned to the offline office to provide network services to subscribers of the network operator who access the network via the remote office 202.

The remote office 202 may be located in any suitable location such as in a neighborhood serving residential customers or business customers over subscriber lines 216. Respective subscriber lines of the subscriber lines 216 are in data communication with subscriber devices such as data terminals 114 and other customer premises equipment (CPE) 215 illustrated in FIG. 1. The remote office 202 may be one of many such remote offices located throughout a service region of the network operator to provide network services to customers. Network services include data communication, content streaming, voice connection, cable television service, access to the public internet, and, generally, any communication provided by facilities of a network such as communications network 125 of FIG. 1.

The remote office 202 in this example includes an access node 204 and access aggregation device 206. In other embodiments, there may be two or more access aggregation devices to improve redundancy and reliability in the network. In an embodiment, EVPN may be used between the two access aggregation devices to make the access node 204 seem to be talking to a single device instead of two discrete devices. The access node 204 provides network termination for the subscriber lines 216 and communicates between the subscriber lines 216 and other portions of the system 200. The access node 204 may multiplex multiple subscriber lines 216 to a network connection. The access node 204 in an embodiment is dual-connected to multiple aggregation devices such as aggregation device 206 The access node 204 may operate similarly to the access node 112 of FIG. 1.

The access aggregation device 206, or a combination of multiple aggregation devices, provides communication between the remote office 202 including the access node 204 and other elements of the system 200, including over the MPLS network 208 and over multiple Ethernet Virtual Private Network (EVPN) connections in a manner to be described herein. The access aggregation device 206 may function as a subscriber access point for customer premise equipment 215. In the example, the EVPN connections include a first EVPN tunnel 218 coupling the remote office 202 and the access aggregation device 206 to the first office 210 and a second EVPN tunnel 220 coupling the remote office 202 and the multiple aggregation devices such as the access aggregation device 206 to the second office 212. The MPLS network 208, in the example implements an internal BGP (iBGP) layer 3 route reflector network. A layer 2 transport overlay is then arranged across the iBGP network. Border Gateway Protocol is a standardized interior/exterior gateway protocol designed to exchange routing and reachability information among autonomous systems. BGP makes routing decisions, for example, through the MPLS network 208, based on pre-defined paths, network policies or rule sets. The internal BGP or iBGP protocol refers to BGP operating between two peers in the same autonomous system, such as the MPLS network 208. BGP is used in the underlay in the example for reachability. In some embodiments, other reachability protocols may be used in place of BGP reachability including for example Opens Shortest Path First (OSPF) or Intermediate System to Intermediate System (ISIS) reachability.

In the example of FIG. 2A, the MPLS network 208 operates as an EVPN route reflector network. Some autonomous systems employing iBGP must have all iBGP peers connect to each other in a full mesh in which every peer device speaks to every other peer directly. Such a full-mesh configuration requires that each router maintain a session with every other router. In large networks, this number of sessions may degrade the performance of routers due to either a lack of memory, high CPU process requirements, or other reasons. Route reflectors (RRs) reduce the number of connections required in a network such as the MPLS network 208. A single router, or multiple routers to provide redundancy, can be designated as an RR. Other routers in the network need only be configured as peers to the RR. Multiple BGP routers in a network such as the MPLS network 208 can peer with a central RR, rather than peering with every other router in a full mesh. The RR acts as an RR server. All the other iBGP routers become RR clients. When one of the iBGP routers advertises a route to the RR, the route advertisement will be reflected to all other iBGP routers in the network. This arrangement can enhance scalability of the iBGP network.

For interconnection between separate autonomous systems, such between two or more aggregation devices such as the access aggregation device 206 and the first office 210 and the second office 212, a virtual private tunnel may be established. When multiple aggregation devices are used, the BNGs may establish a tunnel to each aggregation device, resulting in four tunnels per access node. Two of the tunnels are primary tunnels and activated for operation. Two of the tunnels are backup tunnels and are generally not used until failure of the primary path. In the example, the first EVPN tunnel 218 may be established between the access aggregation device 206 and the first office 210. Similarly, the second EVPN tunnel 220 may be established between the access aggregation device 206 and the second office 212. The EVPN tunnels allow two remote sites, such as the access aggregation device 206 and the first office 210, to reliably exchange routing information and data in a secure and isolated manner. BGP may be used as a generalized signaling protocol to carry information about routes such as the EVPNs that are not part of the public Internet but are internal to the network operator systems such as system 200. Further, multiprotocol BGP may be used in the case of an MPLS layer 3 VPN to exchange VPN labels learned for routes from sites over the MPLS network 208. Layer 3 refers to the network layer of the OSI model which is used for packet forwarding including routing through intermediate routers.

In the example, the first EVPN tunnel 218 and the second EVPN tunnel 220 employ Ethernet VPN. EVPN is a technology for carrying layer 2 Ethernet traffic as a virtual private network using wide area network protocols. Layer 2 refers to the data link layer that transfers data between nodes on a network segment across the physical layer. EVPN may include Ethernet over MPLS, for example.

The first office 210 in the example includes a first Broadband Network Gateway referred to as BNG-A 222. The second office 212 includes a second Broadband Network Gateway referred to as BNG-B 224. The Broadband Network Gateways BNG-A 222 and BNG-B 224 each are associated with an EVPN Virtual Private Wire Service (VPWS) head-end (HE) termination. VPWS, which may also be referred to as virtual leased line (VLL) service or Ethernet over MPLS (EoMPLS) is a way to provide Layer 2 Ethernet-based point-to-point communication over MPLS or IP networks. VPWS uses a pseudo-wire encapsulation for transporting Ethernet traffic over an MPLS tunnel or across an MPLS backbone. With VPWS two sites of the communication network are virtually directly connected as point-to-point, much like a leased line between the points. VPWS service encapsulates network data and transports the data over the network operator's IP or MPLS network in an MPLS tunnel. VPWS provides L2 Ethernet service across a common MPLS network, such as the MPLS network 208. A VPWS instance is configured on each associated edge device for each VPWS Layer 2 VPN.

At the remote office 202, the access aggregation device 206 is also associated with an EVPN VPWS HE termination. By means of the respective EVPN VPWS HE termination services, the access aggregation device 206 may communicate through the first EVPN tunnel 218 with BNG-A 222 of the first office 210. Similarly, by means of the respective EVPN VPWS HE termination services, the access aggregation device 206 may communicate through the second EVPN tunnel 220 with BNG-B 224 of the second office 212.

Thus, IP layer 3 route information is exchanged between the BNG pair, BNG-A 222 and BNG-B 224, along with the access aggregation device 206. In between is the MPLS network 208 which may include any number of devices and any number of router hops. Over the top of that, the BGP devices advertise MPLS labels and route target constraints for EVPN. The BNG devices advertise reachability. Both BNGs have the same, common, service instance built thereon and represent one end of a tunnel. The other end of the is the access aggregation device 206. Thus, both BNG devices advertise reachability to the same service instance, but one BNG, BNG-A 222, indicates it is primary, the other BNG, BNG-B 224, indicates it is in a backup state.

The access aggregation device sees both endpoints, BNG-A 222 and BNG-B 224, equally, with the only differentiating being that BNG-A 222 designates itself as primary, the other BNG, BNG-B 224, designates itself as backup or secondary. Once the BNG devices both signal that designation, then the access aggregation device 206 advertises its own reachability. The network then route reflects, using a route reflector, that information to both BNG devices so that that information is received at both end points. A data plane is then established over the tunnels, including first EVPN tunnel 218 and second EVPN tunnel 220. Each may serve as primary, depending on signaling designation.

Once these tunnel connections are established, there exists in effect a layer 2 path built over a layer 3 network as indicated by the arrow 228. The layer 2 path extends all the way from the access node 204, where communication is typically at layer 2 or just a VLAN context, into the access aggregation device 206. The layer 2 path is then strung over this layer three MPLS network 208 but using MPLS with an EVPN tunnel to the active BNG, BNG-A 222, which can process subscriber data. In effect, the path indicated by arrow 228 may be considered just a long Ethernet segment across all these devices in the middle between the BNG pair and the access node 204.

This arrangement provides substantial flexibility. If there is a network failure in the nominal state illustrated in FIG. 2A, the network withdraws the reachability at layer 3 in the IP realm, and then the BNG pair coordinate coverage. Generally, the two BNG devices maintain, between the two of them, a coordination session through the core network 214. The BNG-B 224 designated as secondary sees the BNG-A 222 designated as primary removed from reachability and changes its status to the primary. The BNG-B 224 readvertises for that same session back through the route reflector of the MPLS network 208, to the access aggregation device 206, to communicate that the BNG is now the primary. The BNG pair have different IP addresses, but they are representing the same session from a tunnel perspective. The access aggregation device 206 sees the advertisement of the BNG-B 224 and reestablishes the tunnel to the same service construct but to a different endpoint IP address. And then the layer 2 segment is just then stretched across to the other device, BNG-B 224. In this manner, restoration of service from a failed primary network connection to the BNG-A 222 to the backup BNG-B 224 may be accomplished rapidly and automatically, in a time delay of single seconds or less, Moreover, the reconfiguration can be done across a multi-vendor arrangement. The system 200 operates independently of vendors of the equipment involved.

The system 200 enables building a pair of BNG service nodes in centralized and geo-diverse offices from access nodes such as the access node 204 connecting the subscribers. The pair of BNG service nodes, such as BNG-A 222 and BNG-B 224, provide an automated failover or redundancy schema that is efficient in restoring service in a timely manner in the event of service outage of one of the pair of BNG service nodes. In addition, traffic may be steered dynamically over an IP based transport network such as the first EVPN tunnel 218 and the second EVPN tunnel 220 to abstract the failover mechanism from the underlying transport network such as the MPLS network 208. This arrangement enables the noted benefits while using standards-based BGP routing protocol announcements for establishing primary and backup access tunnels with EVPN VPWS HE termination. Conventional BNG redundancy schemes have utilized redundant connectivity from a given access node to a pair of inter-connected BNG nodes with a fixed layer 2 transport path to each BNG. Such conventional solutions require more transport fiber to interconnect each access node to non-collocated BNG service nodes. Also, the transport mapping is not dynamic, nor generally based on an IP-routed underlay network for reachability between the access node and the BNG location.

Thus, the system 200 delivers a primary backup solution for a layer 2 construct. As noted, conventionally there is a pseudo-wire or VLAN connection from the access aggregation point or access node to each BNG. If one connection fails, the other connection is activated. However, there are physical connections between the access node, and all access nodes in the network, to both a primary BNG and a secondary BNG, if redundancy is required. The arrangement of FIG. 2A allows a dynamic change from a primary connection to the backup connection for the layer two access through the MPLS network.

Accordingly, a system in accordance with aspects described herein can actually provide geo-resiliency. In embodiments, these are two different physical offices where BNG-A 222 and BNG-B 224 are deployed with no direct physical transport between the two offices, including the first office 210 and the second office 212. The two sites, including the first office 210 and the second office 212, are generally embodied as two separate buildings or locations, with connectivity through the core network 214. Accordingly, the resiliency or redundancy does not rely on a physical transport between the two for synchronization. Redundancy and response to a service outage is handled through what are, in effect, top and bottom rails formed by the first EVPN tunnel 218 and the second EVPN tunnel 220, respectively, that the network is running across. Further, signaling happens between the two BNGs, BNG-A 222 and BNG-B 224, through the core network 214 and there is BGP signaling routing to the access aggregation device 206 to indicate a primary path and a backup path relative to an individual access node. In FIG. 2A, the primary path is formed in part by the first EVPN tunnel 218, labelled Primary Path. The secondary path is formed in part by the second EVPN tunnel 220, labelled Backup Path.

The core network 214 includes a variety of network servers and switches to provide a variety of services, such as access control, redundancy control, billing, and gateway access to the public internet. As indicated, the core network 214 may be in data communication with both the two BNGs, BNG-A 222 and BNG-B 224. A redundancy control 226 may be implemented in any suitable fashion such as by a server with access to current data about network availability and scheduled downtimes, maintenance activities and other events. The redundancy control 226 may be a part of the core network 214 or in data communication with components of the core network 214. For example, when a failed BNG such as BNG-A 222 comes back online, the now-restored BNG determines it has network reachability. The now-restored BNG can report that to the other BNG, BNG-B 224 in this example. In effect, the two BNG devices represent two endpoints of the same logical segment, meaning the layer 2 construct across the MPLS network 208. However, the two BNG devices have a back-channel path through the core network 214 by which they can communicate. That back-channel path may consist of an Ethernet segment constructed through the core network 214.

FIG. 2B depicts an illustrative embodiment of a method 230 for a session establishment process in the system 200 of FIG. 2A, in accordance with various aspects described herein. The method 230 may be performed by any suitable device or combination of devices in the system 200. The method 230 may be used to initialize communication between the access aggregation device 206 (also referred to as access aggregation device 206) and the first broadband gateway BNG-A 222 as a primary gateway and the second broadband gateway BNG-B 224 as the secondary gateway. The method 230 may be initiated in any suitable manner, such as by network personnel configuring network equipment for redundant operation to ensure reliable service.

At step 232, the method 230 includes a process of creating layer 3 internet protocol (IP) underlay reachability between the access aggregation device 206 and the first broadband network gateway node BNG-A 222 and between the access aggregation device 206 and the second broadband gateway node BNG-B 224. In embodiments, this is done using conventional signaling through the transport network, MPLS network 208. An underlay network is the physical infrastructure that forms the foundation of the virtual network. The underlay network consists of switches, routers, and other networking hardware that transport data packets between physical devices. The main function of the underlay network is to forward data packets as quickly and efficiently as possible, making it optimized for low latency and high performance. A routing protocol such as BGP may be used to determine the shortest path between devices, which further enhances performance.

At step 234, the method 230 uses iBGP EVPN reachability to establish Ethernet Virtual Private Network Virtual Private Wire Service Head End Termination (EVPN VPWS HE termination) between the access aggregation device 206 and the BNG nodes, including in this example, the first broadband network gateway node BNG-A 222 and the second broadband gateway node BNG-B 224. In an example, a BGP router that wants to use multi-protocol BGP indicates the type of routes it wants to exchange with a peer by including a corresponding Address Family Identifier (AFI) and a Subsequent Address Family Identifier (SAFI) such as AFI-25, SAFI-70 values in the multi-protocol BGP capability of its messaging.

An Ethernet VPN (EVPN) enables connection of dispersed customer sites such as the access aggregation device 206 using a layer 2 virtual bridge. Virtual private wire service (VPWS) layer 2 VPNs employ layer 2 services over MPLS to build a topology of point-to-point connections that connect customer sites in a VPN. EVPN-VPWS brings the benefit of EVPN to point-to-point service by providing fast convergence upon node failure and link failure through a multi-homing feature.

At step 236, the access aggregation device 206 or the combination of such access aggregation devices advertises an Ethernet Virtual Interface (EVI) reachability from two interfaces in an All-Active signaled mode. Two interfaces are used to enable redundancy. EVI is a network construct that extends a unique network interface at a remote site such as the access aggregation device 206 to provide zero-configuration networking support over a layer 3 routed network. The EVI generally sits at the edge of the network, just before the layer 2 network crosses over to the layer 3 network. Each access node has its own network address for independent connection to the first broadband network gateway node BNG-A 222 and the second broadband gateway node BNG-B 224, respectively.

At step 238, the BNG devices, in this example the first broadband network gateway node BNG-A 222 and the second broadband gateway node BNG-B 224, coordinate the designated forwarder election through the core network 214. In general, the two BNG devices are not collocated and instead are located remotely to provide geographic diversity to ensure reliable network operation in the event of a local failure. The BNG devices are able to communicate and coordinate, however, through the core network 214 and, in the example, through the redundancy control 226.

At step 240, the pair of BNG nodes, such as first broadband network gateway node BNG-A 222 and second broadband gateway node BNG-B 224, each advertise the same EVI reachability representing an access node to the access aggregation device 206. In the illustrated embodiment, the BNG pair uses EVPN signaling related to a common Ethernet Segment with Service Carving parameters for Designated Forwarder (DF) election. An Ethernet segment is an electrical or optical connection between networked devices using a shared medium such as electrical or optical cable. Service carving may be used to specify a list of service identifiers as either active services or standby services. A service-carving algorithm determines the provider edge device or other network element that is the Designated Forwarder (DF) in a given ethernet-segment and for a given service. A designated forwarder is required when customer edge devices (CEs) are multihomed to more than one provider edge (PE) device, such as the first broadband network gateway node BNG-A 222 and the second broadband gateway node BNG-B 224, which form the edge of the MPLS network 208. Without a designated forwarder, multihomed hosts would receive duplicate packets. Designated forwarders are chosen for an Ethernet segment identifier (ESI) based on route advertisements.

Based on the DF election, the first broadband network gateway node BNG-A 222 advertises as primary for the Ethernet Virtual Interface (EVI). Second broadband gateway node BNG-B 224 advertises as secondary for the same EVI. In the same way, the prioritization could be reversed, or any other BNG in the network could be selected to be primary or secondary for the EVI.

At step 242, the access aggregation device 206 selects the primary device advertised for EVI for subscriber VLAN data traffic for a connected access node, i.e., the access node 204. Based on this selection, subscriber VLANs for the access node 204 are mapped to the primary EVPN VPWS tunnel, first EVPN tunnel 218, for transport to the first broadband network gateway node BNG-A 224.

At step 244, the secondary BNG, first broadband network gateway node BNG-B 224, advertises subscriber layer 3 routes to the core network 214 for reachability from the internet but with a lower LOCAL PREF than BNG-A 222. This forces all traffic to BNG-A 222, matching the DF election state/primary and backup designations. During a failure, when primary and backup switch, the LOCAL PREF advertised switches as well. At step 246, subscriber data are communicated between the core network 214 and the access node 204 over the primary path, including first EVPN tunnel 218. The second EVPN tunnel 220 is maintained as a backup or secondary path in the event of a failure affecting the primary path of first EVPN tunnel 218.

FIG. 2C is a block diagram illustrating an example, non-limiting embodiment of the system 200 functioning within the communications network 125 of FIG. 1 in accordance with various aspects described herein. In the example of FIG. 2C, one or more connections between the access aggregation device 206 and the MPLS network 208, or between the MPLS network 208 and the BNG-A 222, has failed. In effect, primary path including the first EVPN tunnel experiences a service outage. The outage may correspond to a network fault, particularly between the access aggregation device 206 and the BNG-A 222, or a total loss of the BNG-A 222. In accordance with various aspects described herein, service is automatically and rapidly switched to the second EVPN tunnel 220 to provide connection over the path indicated by arrow 229 in FIG. 2C.

In this way, the access aggregation device 206 and BNG tunnel endpoints are able to dynamically establish EVPN VPWS HE termination tunnels by only knowing the far end IP address of the other tunnel endpoint and communicating Route Target Constraint (RTC) values. For redundancy, both BNG devices (Active and Standby) announce the same EVPN VPWS (EVI) reachability, but one with a Primary indicator set and the other with a Backup indicator set. The role of Primary and Backup is determined via an EVPN Signaled Ethernet Segment common to both BNGs, where the Service Carving parameter in the ES resolves a DF Election. This Primary indicator is used by the access aggregation device 206 to map the Access Node subscriber contexts to the Active BNG path. In a failover condition, the opposite BNG node only needs to re-advertise the EVPN VPWS (EVI) with the Primary indicator to attract the traffic to that location. No other changes are required to occur in the transport network at the time of the switchover.

FIG. 2D depicts an illustrative embodiment of a method 250 in accordance with various aspects described herein. The method 250 may be performed by any suitable device or combination of devices in the system 200. The method 250 may be initiated by detection of a network fault or other disruption of service in the network.

At step 252, the network fault or failure is detected. The fault or failure operates to interrupt service to subscriber devices in data communication with access node 204 and the access aggregation device 206. Failure of service to the access aggregation device 206 may be detected and communicated in the system 200 in any suitable manner. In one example, for loss of reachability from BNG-A 222 to the access aggregation device 206, a withdrawal of the EVPN Ethernet segment (ES) may be signaled via the core network 214 from the BNG-A 222 to the BNG-B 224. In another example, for loss of the BNG node BNG-A 222, BGP or other IP reachability may be withdrawn via the core network 214 which triggers a similar EVPN Ethernet segment withdrawal on the BNG-B 224. In an embodiment, BGP sessions in the network may use bi-directional forwarding detection (BFD). BFD allows the BGP sessions to determine if there is an issue with either peer, and to do so faster than with normal convergence. This enhances the reliability of the system.

At step 254, designated forwarder (DF) election is switched from BNG-A 222 to BNG-B 224. This may be done in any suitable manner. In an example, the redundancy control 226 detects the network fault or failure at step 252 and automatically responds to the network fault or failure by updating the DF selection. Further in the example, the redundancy control 226 may signal the BNG-B 224 to update the DF election. Thus, for packets directed from the access aggregation device 206, the BNG-B 224, as secondary broadband network gateway, becomes the designated forwarder and packets are routed accordingly to the BNG-B.

At step 256, the BNG-B 224 advertises as the primary for the EVPN VPWS to the access aggregation device 206. At step 258, the mapping of subscriber VLANs on the access aggregation device 206 is moved to the new primary path including the second EVPN tunnel 220, indicated in FIG. 2C by arrow 229. BNG-B 224 takes over as the active BNG for subscribers using the access aggregation device 206. At step 260, the BNG-B 224 advertises subscriber layer 3 routes to the core network 214 for reachability from the public internet to the access aggregation device 206. In particular, the BNG-B 224 advertises the subscriber Layer-3 routes with a higher LOCAL_PREF value than BNG-A 222 which re-advertises its routes with a lower LOCAL_PREF value. Local preference or LOCAL_PREF can be specified to choose an outbound external BGP path from a node. The value may be 100 for PRIMARY and 50 for BACKUP. That with the highest local preference value is preferred. The switchover from primary to backup may thus be completed.

Upon a correction of the network fault, the original configuration may be reinstated. The DF election maybe reverted upon network recovery and the primary path returned to BNG-A 222. This may be done automatically through control of the redundancy control 226 or through human intervention by network operators. Alternatively, the BNG-A 222, upon placement back in service, may advertise reachability. This advertisement may be detected by the BNG-B 224, causing the BNG-B 224 to revert to secondary status. Alternatively, the BNG-B 224 remains the primary BNG, and the BNG-A 222 begins service as the backup device pending a subsequent network failure.

This solution provides a simple IP-Routed and BGP-based networking overlay solution for establishing transport connectivity from multiple access node locations to centralized, but redundant, BNG nodes to better utilize the more costly BNG node resources in a service provider's network. Given that the tunnels are established over an IP routed network, this allows for transport aggregation through BGP-speaking IP-enabled nodes in the transport network as opposed to building direct fiber to both geo-diverse offices for every access node office in the footprint. The redundancy schema is transparent to a subscriber access point such as the access aggregation device 206 which may perceive that it is connecting with a singleton BNG device and have no awareness of the redundant BNG devices.

In a further example, the arrangement of FIG. 2A and FIG. 2C may be used for load balancing or load distribution. For example, a first set of subscribers may be designated for service by BNG-A 222 and a second set of subscribers may be designated for service by BNG-B 224. Through a round-robin selection and deselection of the first EVPN tunnel 218 and the second EVPN tunnel 220, the access node 204 may be selectively coupled to a selected BNG including BNG-A 222 and BNG-B 224. This may be further extended by adding additional BNG devices with EVPN tunnel connections to the access aggregation device 206. Each respective BNG device may be selected, iteratively or periodically or according to any timing, and subscriber traffic maintained for designated subscribers. As noted, the switch between paths and BNGs may occur in less than 10 seconds and thus may be transparent to the subscribers. Switching may be under control of any suitable device including the redundancy control 226.

While for purposes of simplicity of explanation, the respective processes are shown and described as a series of blocks in FIG. 2B and FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

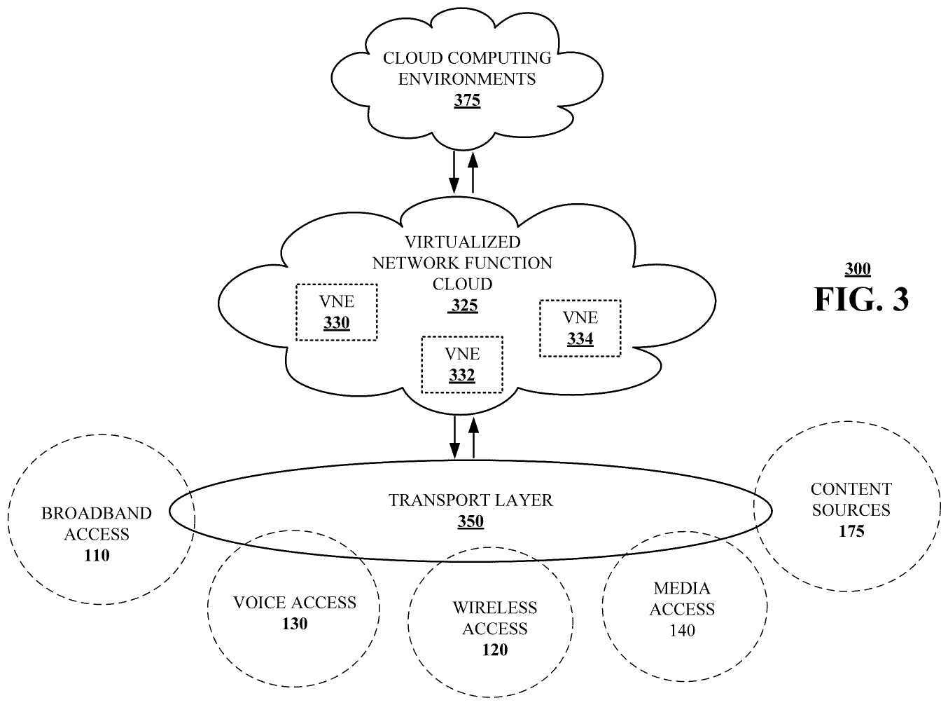

Referring now to FIG. 3, a block diagram is shown illustrating an example, non-limiting embodiment of a virtualized communication network 300 in accordance with various aspects described herein. In particular a virtualized communication network 300 is presented that can be used to implement some or all of the subsystems and functions of system 100, the subsystems and functions of system 200, method 230 and method 250 presented in FIG. 1, FIG. 2A, FIG. 2B, FIG. 2C, FIG. 2D and FIG. 3. For example, virtualized communication network 300 can facilitate in whole or in part establishing a service overlay using layer 2 EVPN VPWS tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

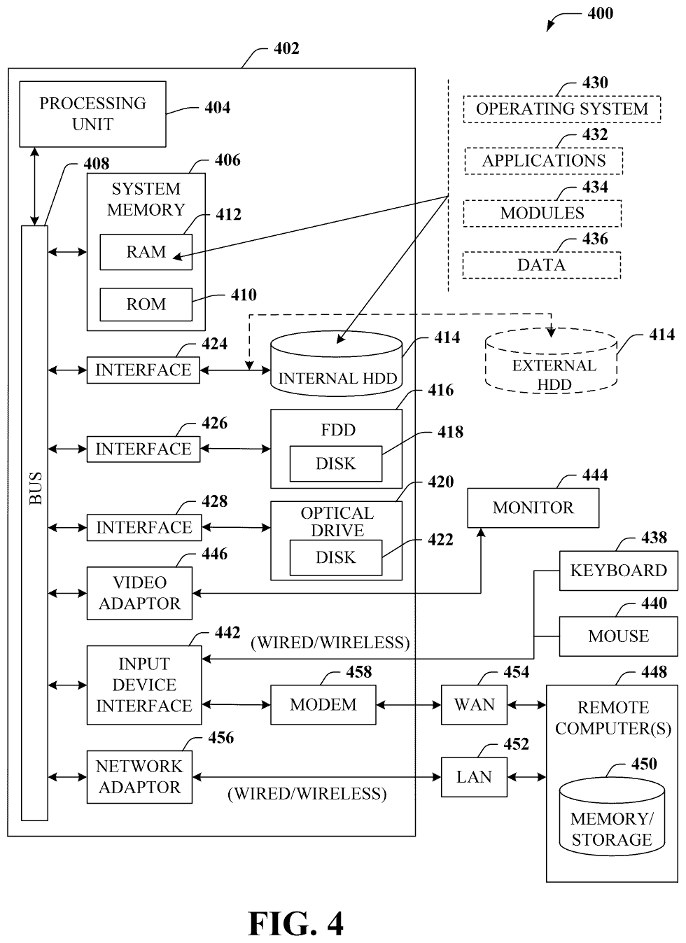

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access node 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part establishing a service overlay using layer 2 EVPN VPWS tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

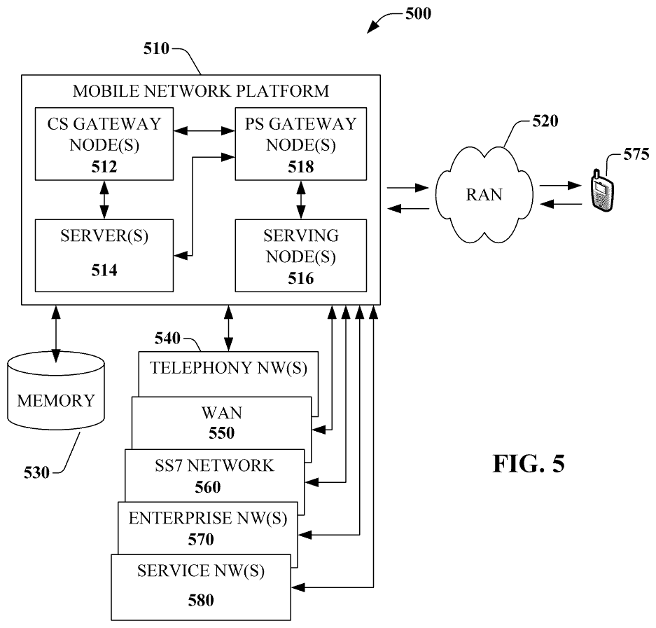

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part establishing a service overlay using layer 2 EVPN VPWS tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

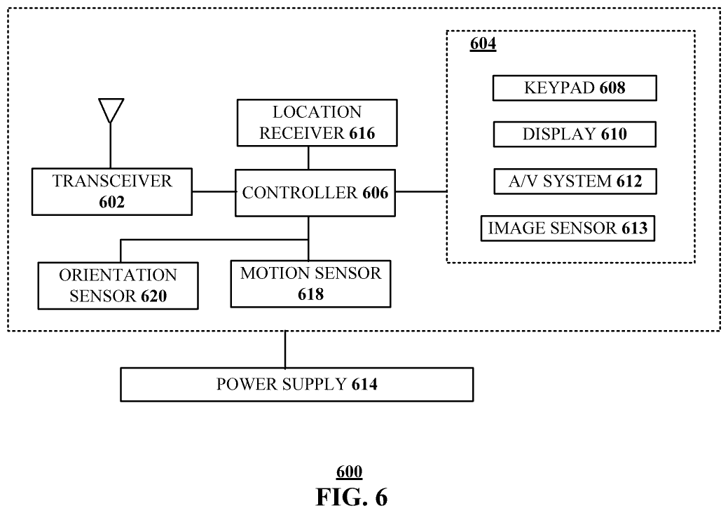

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part establishing a service overlay using layer 2 EVPN VPWS tunnels over a layer 3 transport network to connect a subscriber network access aggregation point to redundant broadband network gateway devices. One gateway is designated as primary and used for subscriber data communication. In the event of a network failure, the redundant or backup gateway is automatically placed into service, all transparently to the subscriber access point.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
creating network reachability on a layer 3 internet protocol underlay network between a subscriber access point and a first broadband network gateway (BNG) and between the subscriber access point and a second BNG;
establishing Ethernet Virtual Private Network Virtual Private Wire Service (EVPN VPWS) Headend (HE) layer 2 termination between the subscriber access point and the first BNG and between the subscriber access point and the second BNG;
receiving a first advertisement of Ethernet Virtual Interface (EVI) reachability from the first BNG;
receiving a second advertisement of EVI reachability from the second BNG;
selecting the first BNG as a primary path for subscriber Virtual Local Area Network (VLAN) traffic for one or more subscriber devices;
mapping a VLAN of the subscriber access point to a first EVPN VPWS tunnel for transport of the subscriber VLAN traffic to the first BNG; and
communicating subscriber VLAN data over the first EVPN VPWS tunnel with the first BNG.

2. The device of claim 1, wherein the operations further comprise:
selecting the second BNG as a secondary path for subscriber Virtual Local Area Network (VLAN) traffic for one or more subscriber devices, wherein the first BNG and the second BNG are operated by a network service provider to provide network access to the one or more subscriber devices at an access node in communication with the subscriber access point.

3. The device of claim 2, wherein the operations further comprise:
detecting a failure of the layer 3 internet protocol underlay network, the failure affecting the network access to the one or more subscriber devices; and
mapping a VLAN of the subscriber access point to a second EVPN VPWS tunnel for transport of the subscriber VLAN traffic to the second BNG for redundancy with the first BNG in the network access to the one or more subscriber devices.

4. The device of claim 1, wherein the operations further comprise:
advertising, by the subscriber access point, network reachability of the subscriber access point, the network reachability of the subscriber access point reflected by a route reflector of the layer 3 internet protocol underlay network to the first BNG and the second BNG; and
mapping the VLAN of the subscriber access point to the first EVPN VPWS tunnel based on the network reachability of the subscriber access point.

5. The device of claim 1, wherein the operations further comprise:
receiving, by the subscriber access point, a first advertisement from the first BNG, the first advertisement advertising reachability of the first BNG, the reachability of the first BNG advertising a service instance at a first network address; and
receiving, by the subscriber access point, a second advertisement from the second BNG, the second advertisement advertising reachability of the second BNG, the reachability of the second BNG advertising a service instance at a second network address, wherein the service instance of the second BNG is the same as the service instance of the second BNG.

6. The device of claim 1, wherein the operations further comprise:
detecting a network failure, the network failure affecting the network access to the one or more subscriber devices;
receiving, from the second BNG, an updated advertisement of reachability;
selecting the second BNG as the primary path for the subscriber VLAN traffic for the one or more subscriber devices;
mapping a VLAN of the subscriber access point to a second EVPN VPWS tunnel for transport of the subscriber VLAN traffic to the second BNG; and
communicating further subscriber VLAN data over the second EVPN VPWS tunnel with the second BNG.

7. The device of claim 6, wherein the receiving, from the second BNG, an updated advertisement of reachability comprises:
receiving the updated advertisement of reachability in response to a signaling of EVPN Ethernet Segment loss of reachability of the first BNG signaled to the second BNG, wherein the first BNG and the second BNG are in data communication through a core network of a network service provider.

8. The device of claim 6, wherein the receiving, from the second BNG, an updated advertisement of reachability comprises:
receiving the updated advertisement of reachability in response to a signaling of loss of Broadband Gateway Protocol (BGP) reachability due to failure of the first BNG, wherein the primary path for the subscriber VLAN traffic is assigned a first local preference value and the secondary path for the subscriber VLAN traffic is assigned a second local preference value, wherein the first local preference value and the second local preference value are switched for the primary path and the secondary path when the second BNG is selected as the primary path for the subscriber VLAN traffic for the one or more subscriber devices.

9. The device of claim 6, wherein the operations further comprise:
receiving, from the first BNG, an updated advertisement of reachability, wherein the receiving the updated advertisement is reachability is responsive to resolution of the network failure and return to normal service;
selecting the first BNG as the primary path for the subscriber VLAN traffic for the one or more subscriber devices;
mapping a VLAN of the subscriber access point to the EVPN VPWS tunnel for transport of the subscriber VLAN traffic to the first BNG; and
communicating future subscriber VLAN data over the first EVPN VPWS tunnel with the first BNG, reverting to an initial network condition.

10. The device of claim 1, wherein the creating network reachability on a layer 3 internet protocol underlay network comprises:
creating network reachability in a multiprotocol label switching (MPLS) network implementing an internal BGP (iBGP) layer 3 route reflector network accessible by the subscriber access point.

11. A non-transitory machine-readable medium, comprising executable instructions that, when executed by a processing system including a processor, facilitate performance of operations, the operations comprising:
creating layer 2 Ethernet Virtual Private Network Virtual Private Wire Service (EVPN VPWS) overlays on a layer 3 internet protocol underlay network to provide network access to a service provider network for a subscriber access point;
establishing first network reachability between the subscriber access point and a first Broadband Network Gateway (BNG);
establishing second network reachability between the subscriber access point and a second Broadband Network Gateway (BNG);
designating one of the first BNG and the second BNG as a primary path and another BNG of the first BNG and the second BNG as a secondary path for network access from the subscriber access point;
communicating subscriber data on the primary path;
detecting a network failure in the service provider network affecting the communicating subscriber data; and
automatically selecting the secondary path for communicating further subscriber data in response to the detecting the network failure.

12. The non-transitory machine-readable medium of claim 11, wherein the operations further comprise:
establishing Ethernet Virtual Private Network Virtual Private Wire Service (EVPN VPWS) Headend (HE) layer 2 termination between the subscriber access point and the first BNG and between the subscriber access point and the second BNG based on internal Bandwidth Gateway Protocol (iBGP) EVPN reachability;
advertising, from the subscriber access point, EVI reachability; and
receiving, from the first BNG and the second BNG, respective advertisements of EVI reachability.

13. The non-transitory machine-readable medium of claim 11, wherein the operations further comprise:
communicating, by the subscriber access point, reachability for subscriber devices in data communication with the subscriber access point, to the primary path for advertisement by the one of the first BNG and the second BNG of subscriber layer 3 routes to a core network of the network service provider.

14. The non-transitory machine-readable medium of claim 11, wherein the operations further comprise:
detecting a withdrawal of the first network reachability of the first BNG, the withdrawal of the first network reachability in response to the network failure in the service provider network; and
designating the secondary path for network access from the subscriber access point as a new primary path; and
reestablishing communication over the secondary path responsive to the detecting the withdrawal of the first network reachability.

15. The non-transitory machine-readable medium of claim 11, wherein the operations further comprise:
receiving a first internet protocol (IP) address of the first BNG; and
receiving a second IP address of the second BNG, the second IP address being different from the first IP address; wherein the first BNG and the second BNG advertise a common service instance.

16. A method, comprising:
establishing, by a processing system including a processor, a first layer 2 Ethernet Virtual Private Network Virtual Private Wire Service (EVPN VPWS) tunnel from a subscriber access point in a service provider network to a first broadband network gateway (BNG) over a layer 3 underlay network;
establishing, by the processing system, a second layer 2 EVPN VPWS tunnel from the subscriber access point to a second broadband network gateway (BNG) over the layer 3 underlay network;
designating the first layer 2 EVPN VPWS tunnel as a primary path for subscriber communication in the service provider network;
designating the second layer 2 EVPN VPWS tunnel as a secondary path for the subscriber communication in the service provider network;
communicating subscriber data on the primary path;
detecting a network failure in the service provider network affecting the communicating subscriber data; and
automatically selecting the second layer 2 EVPN VPWS tunnel for communicating the subscriber data in response to the detecting the network failure.

17. The method of claim 16, further comprising:
receiving, by the processing system, signaling from the first BNG, wherein the signaling from the first BNG advertises first reachability to a first service instance for the first BNG, including receiving an indication from the first BNG that the first BNG is a primary service instance; and
receiving, by the processing system, signaling from the second BNG, wherein the signaling from the second BNG advertises second reachability to a second service instance for the second BNG, the second service instance matching the first service instance, including receiving an indication from the second BNG that the second BNG is a secondary service instance; and
signaling, by the processing system, reachability of the subscriber access point.

18. The method of claim 17, comprising:
detecting, by the processing system, a withdrawal of the first reachability to the first BNG, the withdrawal of the first reachability in response to the network failure in the service provider network; and
receiving, by the processing system, further signaling from the second BNG readvertising second reachability to the second service instance for the second BNG, including receiving an indication from the second BNG that the second BNG is a primary service instance to replace the first BNG.

19. The method of claim 18, comprising:
reestablishing, by the processing system, communication over the second layer 2 EVPN VPWS tunnel responsive to the detecting the withdrawal of the first reachability.

20. The method of claim 16, comprising:
receiving, by the processing system, a first internet protocol (IP) address of the first BNG; and
receiving, by the processing system, a second IP address of the second BNG, the second IP address being different from the first IP address; wherein the first BNG and the second BNG advertise a common service instance.
